(19) United States
(12) Patent Application Publication
(10) Pub. No.: US 2026/0202303 A1
(43) Pub. Date: Jul. 16, 2026

(54) METHOD FOR NONDESTRUCTIVE CHARACTERIZATION OF PORE STRUCTURE OF ROCK SAMPLE, DEVICE, MEDIUM, AND PRODUCT

(71) Applicant: Northeast Petroleum University, Daqing City (CN)

(72) Inventors: Mengdi SUN, Daqing City (CN); Duo WANG, Daqing City (CN); Shijie ZHANG, Daqing City (CN); Zhejun PAN, Daqing City (CN); Bo LIU, Daqing City (CN)

(73) Assignee: Northeast Petroleum University, Daqing City (CN)

(21) Appl. No.: 19/384,436

(22) Filed: Nov. 10, 2025

(30) Foreign Application Priority Data
Jan. 10, 2025 (CN) 202510037685.5

(51) Int. Cl. G01N 15/08; G01N 23/046; G01N 23/202

(52) U.S. Cl. CPC G01N 15/088; G01N 15/0806; G01N 23/046; G01N 23/202; G01N 2223/616

(57) ABSTRACT

The present application provides a method for nondestructive characterization of a pore structure of a rock sample, a device, a medium, and a product, and relates to the field of shale oil and gas. The method includes: preparing a shale sample to be tested; conducting a micro-computed tomography (CT) experiment, an ultra-small-angle neutron scattering experiment, and a small-angle neutron scattering experiment on the shale sample to be tested to extract a first pore volume distribution and a first pore volume percentage, a second pore volume distribution and a second pore volume percentage, and a third pore volume distribution and a third pore volume percentage of the shale sample to be tested; and generating a full-scale pore size distribution curve of the shale sample to be tested based on the extracted pore volume distributions and pore volume percentages of the shale sample to be tested.

### CROSS REFERENCE TO RELATED APPLICATION

This patent application claims the benefit and priority of Chinese Patent Application No. 2025100376855, filed with the China National Intellectual Property Administration on Jan. 10, 2025, the disclosure of which is incorporated by reference herein in its entirety as part of the present application.

### TECHNICAL FIELD

The present application relates to the field of unconventional oil and gas characterization, and in particular, to a method for nondestructive characterization of a pore structure of a rock sample, a device, a medium, and a product.

### BACKGROUND

Shale oil and gas resources possess significant potential and broad prospects for development. Shale pore structures are of great importance for potential assessment, exploration, and development of shale oil and gas resources. However, current research on shale pore structures is limited by its focus on a single scale, and there is a lack of emphasis on full-scale pore structure characterization research.

Traditional intrusive research methods for pore structures cause some damage to the original structures of samples before and after experiments. The same sample cannot be continuously characterized for pore structures at different scales, and the sample needs to be changed. Due to the strong anisotropy of shale samples to be tested, characterization results may be inaccurate.

### SUMMARY

An objective of the present application is to provide a method for nondestructive characterization of a pore structure of a rock sample, a device, a medium, and a product. The present application can ensure continuous characterization of the same sample without damaging the sample, and can achieve accurate characterization of pore structures of the sample at various scales, thereby realizing full-scale combined characterization of the pore structures of the rock sample.

To achieve the above objective, the present application provides the following technical solutions.

In a first aspect, the present application provides a method for nondestructive characterization of a pore structure of a rock sample, including:
preparing a shale sample to be tested;
conducting a micro-computed tomography (CT) experiment on the shale sample to be tested to extract a first pore volume distribution and a first pore volume percentage of the shale sample to be tested;
conducting an ultra-small-angle neutron scattering experiment on the shale sample to be tested after the micro-CT experiment to extract a second pore volume distribution and a second pore volume percentage of the shale sample to be tested;
conducting a small-angle neutron scattering experiment on the shale sample to be tested after the ultra-small-angle neutron scattering experiment to extract a third pore volume distribution and a third pore volume percentage of the shale sample to be tested; and
generating a full-scale pore size distribution curve of the shale sample to be tested based on the first pore volume distribution and the first pore volume percentage, the second pore volume distribution and the second pore volume percentage, and the third pore volume distribution and the third pore volume percentage of the shale sample to be tested.

Optionally, the preparing a shale sample to be tested specifically includes:
collecting shale to be tested with a set mass, a set diameter, and a set thickness from a shale core in a direction perpendicular to a base, and drying the shale to be tested to obtain the shale sample to be tested.

Optionally, the conducting a micro-CT experiment on the shale sample to be tested to extract a first pore volume distribution and a first pore volume percentage of the shale sample to be tested specifically includes:
conducting the micro-CT experiment on the shale sample to be tested to capture sections of the shale sample to be tested at set angles; and
extracting the first pore volume distribution and the first pore volume percentage of the shale sample to be tested by using Avizo software based on the captured sections of the shale sample to be tested at the set angles.

Optionally, conducting an ultra-small-angle neutron scattering experiment on the shale sample to be tested after the micro-CT experiment to extract a second pore volume distribution and a second pore volume percentage of the shale sample to be tested specifically includes:
conducting the ultra-small-angle neutron scattering experiment on the shale sample to be tested after the micro-CT experiment, and collecting neutron scattering data of the ultra-small-angle neutron scattering experiment; and
processing the neutron scattering data of the ultra-small-angle neutron scattering experiment to extract the second pore volume distribution and the second pore volume percentage of the shale sample to be tested.

Optionally, the conducting a small-angle neutron scattering experiment on the shale sample to be tested after the ultra-small-angle neutron scattering experiment to extract a third pore volume distribution and a third pore volume percentage of the shale sample to be tested specifically includes:
conducting the small-angle neutron scattering experiment on the shale sample to be tested after the ultra-small-angle neutron scattering experiment, and collecting neutron scattering data of the small-angle neutron scattering experiment; and
processing the neutron scattering data of the small-angle neutron scattering experiment to extract the third pore volume distribution and the third pore volume percentage of the shale sample to be tested.

Optionally, the neutron scattering data of the ultra-small-angle neutron scattering experiment and the neutron scattering data of the small-angle neutron scattering experiment each include a scattering vector and a scattering intensity.

Optionally, the neutron scattering data of the ultra-small-angle neutron scattering experiment is processed by using IGOR Pro software; and the neutron scattering data of the small-angle neutron scattering experiment is processed by using the IGOR Pro software.

In a second aspect, the present application provides a computer device, including a memory, a processor, and a computer program stored on the memory and runnable on the processor, where the processor is configured to execute the computer program to implement the steps of any method for nondestructive characterization of a pore structure of a rock sample described above.

In a third aspect, the present application provides a computer-readable storage medium, having a computer program stored thereon, where the computer program, when executed by a processor, causes the steps of any method for nondestructive characterization of a pore structure of a rock sample described above to be implemented.

In a fourth aspect, the present application provides a computer program product, including a computer program which, when executed by a processor, causes the steps of any method for nondestructive characterization of a pore structure of a rock sample described above to be implemented.

According to specific embodiments provided in the present application, the present application has the following technical effects.

The present application provides a method for nondestructive characterization of a pore structure of a rock sample, a device, a medium, and a product. The micro-CT experiment is conducted on the shale sample to be tested to extract the first pore volume distribution and the first pore volume percentage of the shale sample to be tested. The ultra-small-angle neutron scattering experiment is conducted on the shale sample to be tested after the micro-CT experiment to extract the second pore volume distribution and the second pore volume percentage of the shale sample to be tested. The small-angle neutron scattering experiment is conducted on the shale sample to be tested after the ultra-small-angle neutron scattering experiment to extract the third pore volume distribution and the third pore volume percentage of the shale sample to be tested. Accordingly, the problem of easily causing damage to the sample during the experiments can be solved, and the continuous characterization of the same sample can be ensured. By generating the full-scale pore size distribution curve of the shale sample to be tested based on the first pore volume distribution and the first pore volume percentage, the second pore volume distribution and the second pore volume percentage, and the third pore volume distribution and the third pore volume percentage of the shale sample to be tested, the problem of failing to continuously characterize the pore structures of the same sample at different scales can be solved, thereby achieving full-scale combined characterization of the pore structures of the rock sample.

### BRIEF DESCRIPTION OF THE DRAWINGS

To describe the technical solutions in the embodiments of the present application or in the related art more clearly, the following briefly describes the accompanying drawings required for describing the embodiments or the related art. Apparently, the accompanying drawings in the following description show some embodiments of the present application, and a person of ordinary skill in the art may still derive other accompanying drawings from these accompanying drawings without creative efforts.

FIG. 1 is a flowchart of a method for nondestructive characterization of a pore structure of a rock sample provided by an embodiment of the present application;

FIG. 2 is a schematic diagram of pore distributions of a shale sample in a method for nondestructive characterization of a pore structure of a rock sample provided by an embodiment of the present application; and

FIG. 3 is a schematic structural diagram of a computer device provided by an embodiment of the present application.

### DETAILED DESCRIPTION OF THE EMBODIMENTS

The technical solutions in the embodiments of the present application will be described clearly and completely below with reference to the accompanying drawings in the embodiments of the present application. Apparently, the described embodiments are merely some rather than all of the embodiments of the present application. All other embodiments derived from the embodiments in the present application by those of ordinary skill in the art without creative efforts should fall within the protection scope of the present application.

To make the above objective, features, and advantages of the present application more obvious and easier to understand, the present application will be further described in detail with reference to the accompanying drawings and specific implementations.

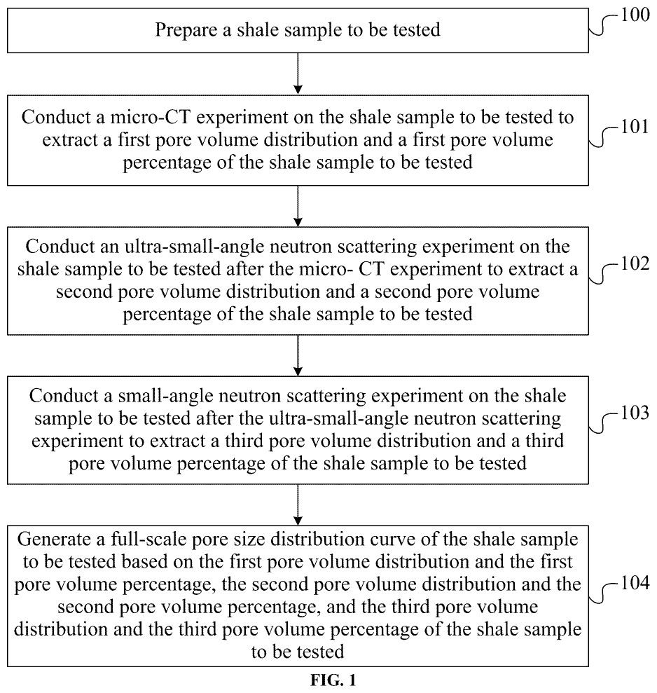

In an exemplary embodiment, as shown in FIG. 1, there is provided a method for nondestructive characterization of a pore structure of a rock sample, including the following steps 100 to 104. The steps are described below.

In step 100, a shale sample to be tested is prepared.

In step 101, a micro-CT experiment is conducted on the shale sample to be tested to extract a first pore volume distribution and a first pore volume percentage of the shale sample to be tested.

In step 102, an ultra-small-angle neutron scattering experiment is conducted on the shale sample to be tested after the micro-CT experiment to extract a second pore volume distribution and a second pore volume percentage of the shale sample to be tested.

In step 103, a small-angle neutron scattering experiment is conducted on the shale sample to be tested after the ultra-small-angle neutron scattering experiment to extract a third pore volume distribution and a third pore volume percentage of the shale sample to be tested.

In step 104, a full-scale pore size distribution curve of the shale sample to be tested is generated based on the first pore volume distribution and the first pore volume percentage, the second pore volume distribution and the second pore volume percentage, and the third pore volume distribution and the third pore volume percentage of the shale sample to be tested.

By performing the above steps 100 to 104, continuous characterization of the same sample can be ensured without damaging the sample. Moreover, accurate characterization of pore structures of the sample at various scales can be achieved, thereby realizing full-scale combined characterization of the pore structures of the rock sample.

In another exemplary embodiment of the present application, in order to ensure the results of the experiments, the target shale needs to be correspondingly prepared.

For example, an approach for preparing the shale sample is as follows.

Shale with a certain mass in a direction perpendicular to a base is taken from a target shale core sample and formed into a circular slice having a diameter of 2.0 cm and a thickness of 0.5 mm. The resulting slice is further dried to obtain a shale sample to be tested, where the drying is performed in a drying oven at 70° C. for 24 hours.

In another exemplary embodiment of the present application, to characterize a pore structure of a shale sample to be tested, a micro-CT experiment is conducted on the shale sample to be tested in this experiment to extract a first pore volume distribution and a first pore volume percentage of the shale sample to be tested, where the micro-CT experiment is completed on GE Nanotom S X-ray scanner.

In practical use, the process of conducting the micro-CT experiment on the shale sample to be tested specifically includes the following steps.

In a first step, the surface of the shale sample to be tested is cleaned to remove surface contaminants, avoiding interference with scanning results.

In a second step, the shale sample to be tested is fixed and vertically placed in a micro-CT scanning device.

In a third step, during a scanning process, the shale sample to be tested remains static, and rotates along with an X-ray source and a detector to capture sections of the shale sample to be tested at various angles. In this process, a micro-CT scanning voltage is 60 kV, an experimental temperature is 20° C., and an exposure time per scan is 2 seconds.

In a fourth step, an image sequence in a tagged image file format (TIFF) for the shale sample to be tested generated by micro-CT is imported to Avizo software (e.g., visual software for geological science). After a correct resolution and a correct pixel size are set, data is preprocessed such that the data volume is clarified. Three-dimensional reconstruction and visualization of the sample are then performed, and a pore volume distribution with a pore diameter of greater than 2 μm of the shale sample to be tested and a volume percentage thereof are extracted.

In another exemplary embodiment of the present application, to comprehensively characterize a pore structure of a shale sample to be tested, an ultra-small-angle neutron scattering experiment is conducted on the shale sample to be tested in this experiment to extract a second pore volume distribution and a second pore volume percentage of the shale sample to be tested, where the ultra-small-angle neutron scattering experiment is conducted by using the general-purpose small-angle neutron scattering (GP-SANS) instrument of Oak Ridge National Laboratory (ORNL).

In an actual experiment, the process of conducting the ultra-small-angle neutron scattering experiment on the shale sample to be tested specifically includes the following steps.

In a first step, after the micro-CT experiment is finished, the sample is placed on a sample stage of ultra-small-angle neutron scattering equipment. It should be ensured that the sample is placed correctly and fixed in the central position. Moreover, the position and the angle of the sample are adjusted, ensuring that a neutron beam can correctly irradiate onto the sample.

In a second step, a neutron source is adjusted such that a neutron wavelength λ is equal to 2.4 Å, and a scattering intensity Q value is in the following range: 5×10⁻⁵<Q<0.00266 Å⁻¹.

In a third step, the ultra-small-angle neutron scattering equipment is turned on to start the ultra-small-angle neutron scattering experiment and collect neutron scattering data.

In a fourth step, the scattering data is analyzed and processed using IGOR Pro software (data analysis and drawing software) to obtain a scattering vector of the sample, and by analyzing the pore structure and the pore size distribution information thereof, a pore volume distribution with a pore diameter of 20 nm to 2 μm of the shale sample to be tested and a volume percentage thereof are extracted.

In another exemplary embodiment of the present application, to more comprehensively characterize a pore structure of a shale sample to be tested, a small-angle neutron scattering experiment is conducted on the shale sample to be tested in this experiment to extract a third pore volume distribution and a third pore volume percentage of the shale sample to be tested, where the small-angle neutron scattering experiment is conducted by using the GP-SANS instrument of ORNL.

In an actual experiment, the process of conducting the small-angle neutron scattering experiment on the shale sample to be tested specifically includes the following steps.

In a first step, after the ultra-small-angle neutron scattering experiment is finished, the sample is placed on a sample stage of small-angle neutron scattering equipment. It should be ensured that the sample is placed correctly and fixed in the central position. Moreover, the position and the angle of the sample are adjusted, ensuring that a neutron beam can correctly irradiate onto the sample.

In a second step, a neutron source is adjusted such that a neutron wavelength λ is equal to 12 Å, or a neutron wavelength λ is equal to 4.72 Å, and a scattering intensity Q value is in the following range: 0.001<Q<0.5 Å⁻¹.

In a third step, the small-angle neutron scattering equipment is turned on to start the small-angle neutron scattering experiment and collect the neutron scattering data.

In a fourth step, the scattering data is analyzed and processed using IGOR Pro software to obtain a scattering vector of the sample, and by analyzing the pore structure and the pore size distribution information thereof, a pore volume distribution with a pore diameter of 0 to 20 nm of the shale sample to be tested and a volume percentage thereof are extracted.

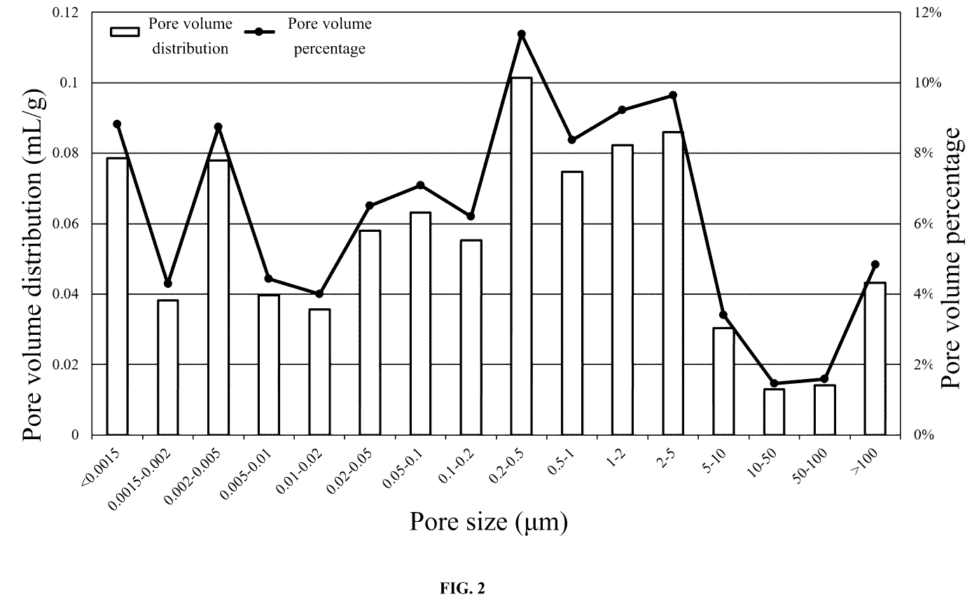

Based on the above description, a full-scale pore size distribution curve of the shale sample to be tested is generated based on the first pore volume distribution and the first pore volume percentage, the second pore volume distribution and the second pore volume percentage, and the third pore volume distribution and the third pore volume percentage of the shale sample to be tested, as shown in FIG. 2.

In the present application, full-scale combined characterization of pore structures of rock samples is enabled by using small-angle neutron scattering, ultra-small-angle neutron scattering, and micro-CT techniques. The method of characterizing a pore structure of a rock sample by combining neutron scattering and CT techniques is initiatively proposed. Compared with conventional methods, such as high pressure mercury injection and gas adsorption, this method has the following advantages: First, there is no damage to the sample during experimentation, allowing for continuous experiments on the same sample. Second, both neutron scattering and CT experiments can capture all pores (both connected and isolated) in shale samples at their respective scales, thereby yielding more accurate characterization results.

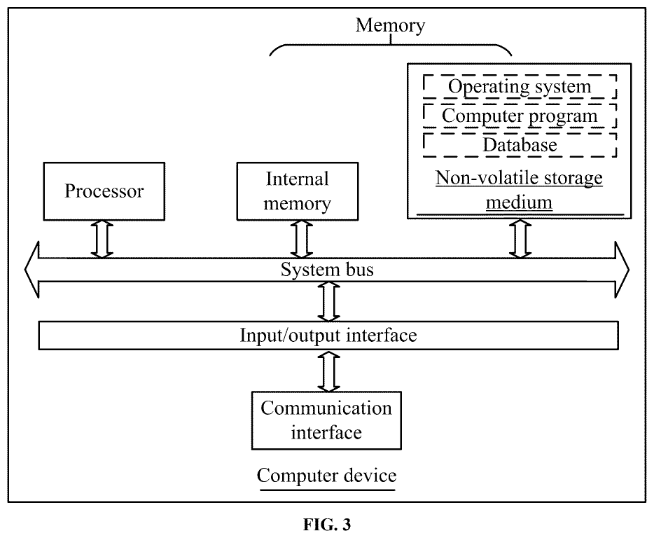

In an embodiment, a computer device is provided. The computer device may be a server or a terminal, and an internal structure thereof may be as shown in FIG. 3. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer apparatus includes a nonvolatile storage medium, and an internal memory. The non-volatile storage medium stores an operating system, a computer program, and a database. The internal memory provides an environment for operation of the operating system and the computer program in the nonvolatile storage medium. The database of the computer device is configured to store data. The input/output interface of the computer apparatus is configured to exchange information between the processor and an external apparatus. The communication interface of the computer apparatus is configured to communicate with an external terminal through a network. The computer program, when executed by the processor, causes a method for nondestructive characterization of a pore structure of a rock sample to be implemented.

Those skilled in the art may understand that the structure shown in FIG. 3 is only a block diagram of a part of the structure related to the solution of the present disclosure and does not constitute a limitation on a computer device to which the solution of the present disclosure is applied. Specifically, the computer device may include more or less components than those shown in the figure, or combine some components, or have different component arrangements. In an embodiment, a computer device is provided, including a memory and a processor, where the memory stores a computer program, and the computer program is executed by the processor to implement the steps of the above method embodiment.

In an embodiment, a computer-readable storage medium is provided. The computer-readable storage medium stores a computer program, and the computer program is executed by a processor to implement the steps of the above method embodiment.

In an embodiment, a computer program product is provided. The computer program product includes a computer program, and the computer program is executed by a processor to implement the steps of the above method embodiment.

It is to be noted that the information of a user (including but not limited to device information of the user, personal information of the user and the like) and data (including but not limited to data for analysis, data for storage, data for exhibition and the like) in the present disclosure are information and data authorized by the user or fully authorized by each party, and the information and data are acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present application. The description of the foregoing examples is used to help illustrate the method of the present application and the core principles thereof. In addition, those of ordinary skill in the art can make various modifications in terms of specific implementations and scope of application in accordance with the teachings of the present application. In conclusion, the content of the present specification shall not be construed as a limitation to the present application.

What is claimed is:

1. A method for nondestructive characterization of a pore structure of a rock sample, comprising:
preparing a shale sample to be tested;
conducting a micro-computed tomography (CT) experiment on the shale sample to be tested to extract a first pore volume distribution and a first pore volume percentage of the shale sample to be tested;
conducting an ultra-small-angle neutron scattering experiment on the shale sample to be tested after the micro-CT experiment to extract a second pore volume distribution and a second pore volume percentage of the shale sample to be tested;
conducting a small-angle neutron scattering experiment on the shale sample to be tested after the ultra-small-angle neutron scattering experiment to extract a third pore volume distribution and a third pore volume percentage of the shale sample to be tested; and
generating a full-scale pore size distribution curve of the shale sample to be tested based on the first pore volume distribution and the first pore volume percentage, the second pore volume distribution and the second pore volume percentage, and the third pore volume distribution and the third pore volume percentage of the shale sample to be tested.

2. The method for nondestructive characterization of a pore structure of a rock sample according to claim 1, wherein the preparing a shale sample to be tested comprises:
collecting shale to be tested with a set mass, a set diameter, and a set thickness from a shale core in a direction perpendicular to a base, and drying the shale to be tested to obtain the shale sample to be tested.

3. The method for nondestructive characterization of a pore structure of a rock sample according to claim 1, wherein the conducting a micro-CT experiment on the shale sample to be tested to extract a first pore volume distribution and a first pore volume percentage of the shale sample to be tested comprises:
conducting the micro-CT experiment on the shale sample to be tested to capture sections of the shale sample to be tested at set angles; and
extracting the first pore volume distribution and the first pore volume percentage of the shale sample to be tested by using Avizo software based on the captured sections of the shale sample to be tested at the set angles.

4. The method for nondestructive characterization of a pore structure of a rock sample according to claim 1, wherein the conducting an ultra-small-angle neutron scattering experiment on the shale sample to be tested after the micro-CT experiment to extract a second pore volume distribution and a second pore volume percentage of the shale sample to be tested comprises:
conducting the ultra-small-angle neutron scattering experiment on the shale sample to be tested after the micro-CT experiment, and collecting neutron scattering data of the ultra-small-angle neutron scattering experiment; and
processing the neutron scattering data of the ultra-small-angle neutron scattering experiment to extract the second pore volume distribution and the second pore volume percentage of the shale sample to be tested.

5. The method for nondestructive characterization of a pore structure of a rock sample according to claim 1, wherein the conducting a small-angle neutron scattering experiment on the shale sample to be tested after the ultra-small-angle neutron scattering experiment to extract a third pore volume distribution and a third pore volume percentage of the shale sample to be tested comprises:
conducting the small-angle neutron scattering experiment on the shale sample to be tested after the ultra-small-angle neutron scattering experiment, and collecting neutron scattering data of the small-angle neutron scattering experiment; and
processing the neutron scattering data of the small-angle neutron scattering experiment to extract the third pore volume distribution and the third pore volume percentage of the shale sample to be tested.

6. The method for nondestructive characterization of a pore structure of a rock sample according to claim 4, wherein the neutron scattering data of the ultra-small-angle neutron scattering experiment and the neutron scattering data of the small-angle neutron scattering experiment each comprise a scattering vector and a scattering intensity.

7. The method for nondestructive characterization of a pore structure of a rock sample according to claim 4, wherein the neutron scattering data of the ultra-small-angle neutron scattering experiment is processed by using IGOR Pro software; and the neutron scattering data of the small-angle neutron scattering experiment is processed by using the IGOR Pro software.

8. A computer device, comprising: a memory, a processor, and a computer program stored on the memory and runnable on the processor, wherein the processor is configured to execute the computer program to implement the method for nondestructive characterization of a pore structure of a rock sample according to claim 1.

9. The method for nondestructive characterization of a pore structure of a rock sample according to claim 5, wherein the neutron scattering data of the ultra-small-angle neutron scattering experiment and the neutron scattering data of the small-angle neutron scattering experiment each comprise a scattering vector and a scattering intensity.

10. The method for nondestructive characterization of a pore structure of a rock sample according to claim 5, wherein the neutron scattering data of the ultra-small-angle neutron scattering experiment is processed by using IGOR Pro software; and the neutron scattering data of the small-angle neutron scattering experiment is processed by using the IGOR Pro software.

11. The computer device according to claim 8, wherein the preparing a shale sample to be tested comprises:
collecting shale to be tested with a set mass, a set diameter, and a set thickness from a shale core in a direction perpendicular to a base, and drying the shale to be tested to obtain the shale sample to be tested.

12. The computer device according to claim 8, wherein the conducting a micro-CT experiment on the shale sample to be tested to extract a first pore volume distribution and a first pore volume percentage of the shale sample to be tested comprises:
conducting the micro-CT experiment on the shale sample to be tested to capture sections of the shale sample to be tested at set angles; and
extracting the first pore volume distribution and the first pore volume percentage of the shale sample to be tested by using Avizo software based on the captured sections of the shale sample to be tested at the set angles.

13. The computer device according to claim 8, wherein the conducting an ultra-small-angle neutron scattering experiment on the shale sample to be tested after the micro-CT experiment to extract a second pore volume distribution and a second pore volume percentage of the shale sample to be tested comprises:
conducting the ultra-small-angle neutron scattering experiment on the shale sample to be tested after the micro-CT experiment, and collecting neutron scattering data of the ultra-small-angle neutron scattering experiment; and
processing the neutron scattering data of the ultra-small-angle neutron scattering experiment to extract the second pore volume distribution and the second pore volume percentage of the shale sample to be tested.

14. The computer device according to claim 8, wherein the conducting a small-angle neutron scattering experiment on the shale sample to be tested after the ultra-small-angle neutron scattering experiment to extract a third pore volume distribution and a third pore volume percentage of the shale sample to be tested comprises:
conducting the small-angle neutron scattering experiment on the shale sample to be tested after the ultra-small-angle neutron scattering experiment, and collecting neutron scattering data of the small-angle neutron scattering experiment; and
processing the neutron scattering data of the small-angle neutron scattering experiment to extract the third pore volume distribution and the third pore volume percentage of the shale sample to be tested.

15. The computer device according to claim 13, wherein the neutron scattering data of the ultra-small-angle neutron scattering experiment and the neutron scattering data of the small-angle neutron scattering experiment each comprise a scattering vector and a scattering intensity.

16. The computer device according to claim 13, wherein the neutron scattering data of the ultra-small-angle neutron scattering experiment is processed by using IGOR Pro software; and the neutron scattering data of the small-angle neutron scattering experiment is processed by using the IGOR Pro software.
